(19) United States
(12) Patent Application Publication
(10) Pub. No.: US 2026/0213826 A1
(43) Pub. Date: Jul. 23, 2026

(54) CONFIDENCE LEVELS FOR BEAM CORRESPONDENCE VIA UPLINK TRANSMISSION BEAM PREDICTION

(71) Applicant: QUALCOMM Incorporated, San Diego, CA (US)

(72) Inventors: Qiaoyu LI, Beijing (CN); Junyi LI, Greentown, PA (US); Mahmoud TAHERZADEH BOROUJENI, San Diego, CA (US)

(21) Appl. No.: 19/157,929

(22) PCT Filed: Mar. 27, 2023
(86) PCT No.: PCT/CN2023/084007

§ 371 Date: Aug. 19, 2025

(51) Int. Cl. H04B 7/06

(52) U.S. Cl. CPC H04B 7/06966

(57) ABSTRACT

Method and apparatus for a configuration for confidence levels associated for beam correspondence for uplink transmission beam predictions. The apparatus performs an uplink transmission beam prediction procedure based on at least one downlink transmission, wherein a predicted uplink transmission beam is selected based on a set of confidence levels for a beam correspondence. The apparatus transmits an indication of support for a beam correspondence capability for the uplink transmission beam prediction procedure meeting at least one of the set of confidence levels for the beam correspondence. The apparatus may report the support for multiple capabilities associated with the set of confidence levels for the beam correspondence.

### TECHNICAL FIELD

The present disclosure relates generally to communication systems, and more particularly, to a configuration for confidence levels associated for beam correspondence for uplink transmission beam predictions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus performs an uplink transmission beam prediction procedure based on at least one downlink transmission, wherein a predicted uplink transmission beam is selected based on a set of confidence levels for a beam correspondence; and transmits an indication of support for a beam correspondence capability for the uplink transmission beam prediction procedure meeting at least one of the set of confidence levels for the beam correspondence.

In an aspect of the disclosure, a method, a computer-readable medium, and an apparatus are provided. The apparatus may be a device at a network node. The device may be a processor and/or a modem at a network node or the network node itself. The apparatus provides at least one downlink transmission, wherein a user equipment (UE) performs an uplink transmission beam prediction procedure based on the at least one downlink transmission; and obtaining an indication that the UE supports a beam correspondence capability for the uplink transmission beam prediction procedure meeting at least one of a set of confidence levels for the beam correspondence, wherein a predicted uplink transmission beam is selected based on the set of confidence levels for the beam correspondence.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of an artificial intelligence (AI)/machine learning (ML) algorithm.

FIG. 5 is a diagram illustrating an example of beam prediction for an uplink transmission beam.

FIG. 6 is a diagram illustrating an example of an uplink transmission beam identification procedure and a beam correspondence procedure.

FIG. 7 is a diagram illustrating an example of an identified uplink transmission beam and a predicted uplink transmission beam.

FIG. 8 is a diagram illustrating an example of beam correspondence based on uplink beam prediction.

FIG. 9 is a diagram illustrating an example of prediction cycles and measurement cycles.

FIG. 10 is a call flow diagram of signaling between a UE and a base station.

FIG. 11 is a flowchart of a method of wireless communication.

FIG. 12 is a flowchart of a method of wireless communication.

FIG. 13 is a diagram illustrating an example of a hardware implementation for an example apparatus and/or network entity.

FIG. 14 is a flowchart of a method of wireless communication.

FIG. 15 is a flowchart of a method of wireless communication.

FIG. 16 is a diagram illustrating an example of a hardware implementation for an example network entity.

### DETAILED DESCRIPTION

Beam correspondence, for some UEs, may comprise different components, such as, for example UE minimum peak equivalent isotropic radiated power (EIRP), UE spherical coverage, and beam correspondence tolerance. Beam correspondence may be fulfilled in instances where a UE satisfies certain conditions, based at least on the beam correspondence capability of the UE. Beam correspondence may be applied in different instances. For example, in instances where the downlink reference signals include both synchronization signal block (SSB) and channel state information reference signals (CSI-RS) are provided and Type D quasi co-location is to be maintained between the SSB and CSI-RS. Beam correspondence may be applied in instances where a reference measurement channel for beam correspondence is fulfilled based on a CSI-RS configuration. UEs may have an acceptable prediction accuracy for predicting a downlink transmission beam's Layer 1 (L1) reference signal received power (RSRP), such that a beam correspondence may be associated with uplink transmission beams that are determined based on predicted downlink transmission beams. However, the prediction accuracy for downlink transmission beams may be unreliable.

Aspects presented herein provide a configuration for confidence levels associated for beam correspondence for uplink transmission beam predictions. For example, beam correspondence may be supported in instances where uplink transmission beam predictions are carried out regardless of whether a prediction accuracy for L1 RSRP of a downlink transmission beam. At least one advantage of the disclosure is the decoupling of the downlink transmission beam prediction accuracy with beam correspondence for uplink transmission beam predictions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

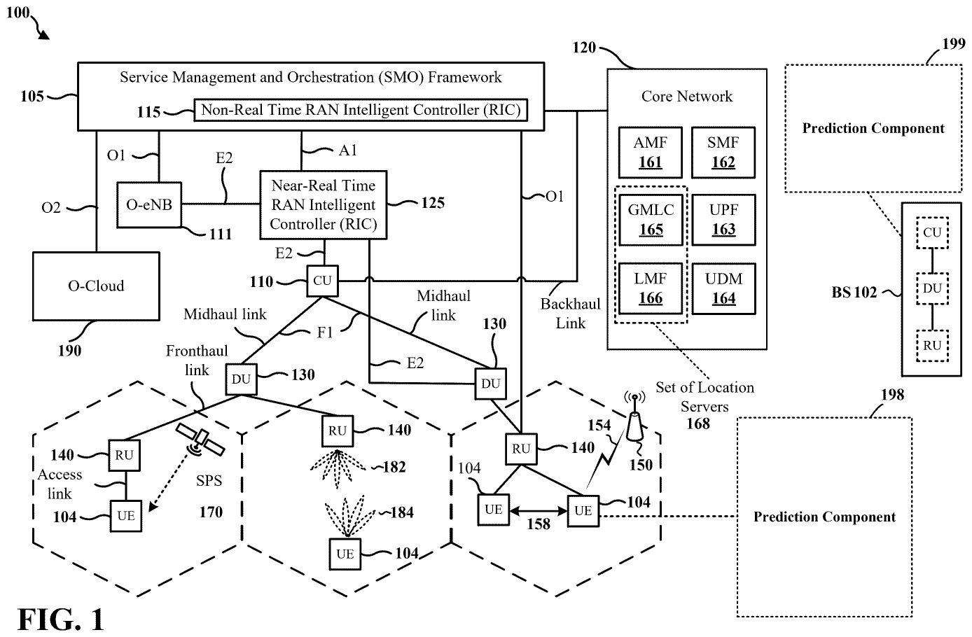

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHZ-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a prediction component 198 configured to perform an uplink transmission beam prediction procedure based on at least one downlink transmission, wherein a predicted uplink transmission beam is selected based on a set of confidence levels for a beam correspondence; and transmit an indication of support for a beam correspondence capability for the uplink transmission beam prediction procedure meeting at least one of the set of confidence levels for the beam correspondence.

Referring again to FIG. 1, in certain aspects, the base station 102 may comprise a prediction component 199 configured to provide at least one downlink transmission, wherein a UE performs an uplink transmission beam prediction procedure based on the at least one downlink transmission; and obtain an indication that the UE supports a beam correspondence capability for the uplink transmission beam prediction procedure meeting at least one of a set of confidence levels for the beam correspondence, wherein a predicted uplink transmission beam is selected based on the set of confidence levels for the beam correspondence.

Although the following description may be focused on 5G NR, the concepts described herein may be applicable to other similar areas, such as LTE, LTE-A, CDMA, GSM, and other wireless technologies.

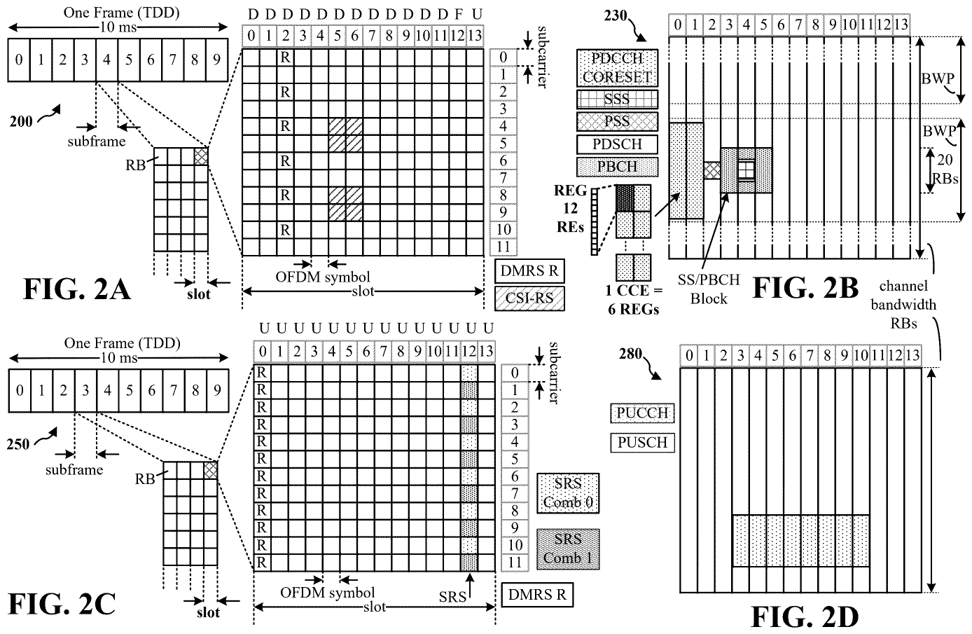

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information ((DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and CSI-RS for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

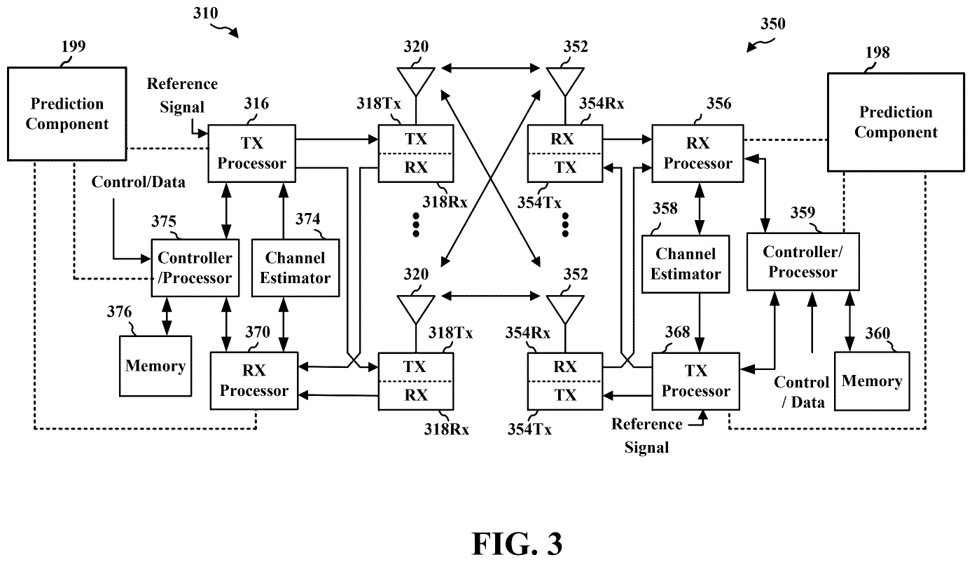

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the prediction component 198 of FIG. 1.

At least one of the TX processor 316, the RX processor 370, and the controller/processor 375 may be configured to perform aspects in connection with the prediction component 199 of FIG. 1.

The UE and the network may perform various aspects of beam management in order to select a beam for transmission and reception. In some aspects, beam management may be performed using a tracking reference signal (TRS), e.g., for a UE in an RRC inactive or RRC idle state. For initial access, a UE may use an SSB, e.g., with a wide beam sweeping procedure to identify a beam to use for initial access. For contention based random access (CBRA), a UE may use a random access occasion (RO) and a preamble that corresponds to the selected SSB/beam. In an RRC connected state, the UE and/or network may perform various aspects of beam management, e.g., including a P1, P2, and P3 procedure using SSB or CSI-RS measurements; a U1, U2, and U3 procedure using SRS transmissions and measurement, L1-RSRP reporting. The network may configure one or more TCI state configurations for the UE, and may indicate a TCI state for the UE from the configured set of TCI states. In some aspects, the UE may provide L1-SINR reporting, which may reduce overhead and latency and allow for CC group beam updates or faster UL beam updates. In some aspects, the UE may communicate with the network using unified TCI states, L1/L2 centric mobility (which may also be referred to a L1/L2 triggered mobility (LTM), dynamic TCI updates, and/or uplink multi-panel selection, maximum permissible exposure (MPE) migration. Beam management may be employed for particular scenarios, such as high speed (e.g., high speed train (HST)), single frequency network (SNF), multiple transmission reception points (mTRP), among other examples. Based on measurements, a UE may identify a beam failure detection (BFD) and may perform a beam failure recovery (BFD). In some aspects, the BFD or BFR may be for a primary cell (PCell) or a primary secondary cell (PSCell). BFD may be based on a BFD reference signal (BFD-RS) and a PDCCH block error rate (BLER). The BFR may be based on a contention free random access (CFRA). For an SCell, the BFD and BFR may include a link recovery request via a scheduling request (SR), or a MAC-CE based BFR for the SCell. If the BFR is unsuccessful, the UE may identify a radio link failure.

Some wireless communication may include the use of AI or ML at the network and/or at the UE. Among various examples, AI/ML may be used for beam management at a UE and/or a network, including for performing beam predictions in a time domain and/or spatial domain. The use of an AI/ML model may reduce latency or overhead and may improve the accuracy of beam selection. Models may be provided that support various levels of network and UE collaboration and to support various use cases. The use of an AI/ML model may include various aspects such as model training, model deployment, model inference, model monitoring, and model updated.

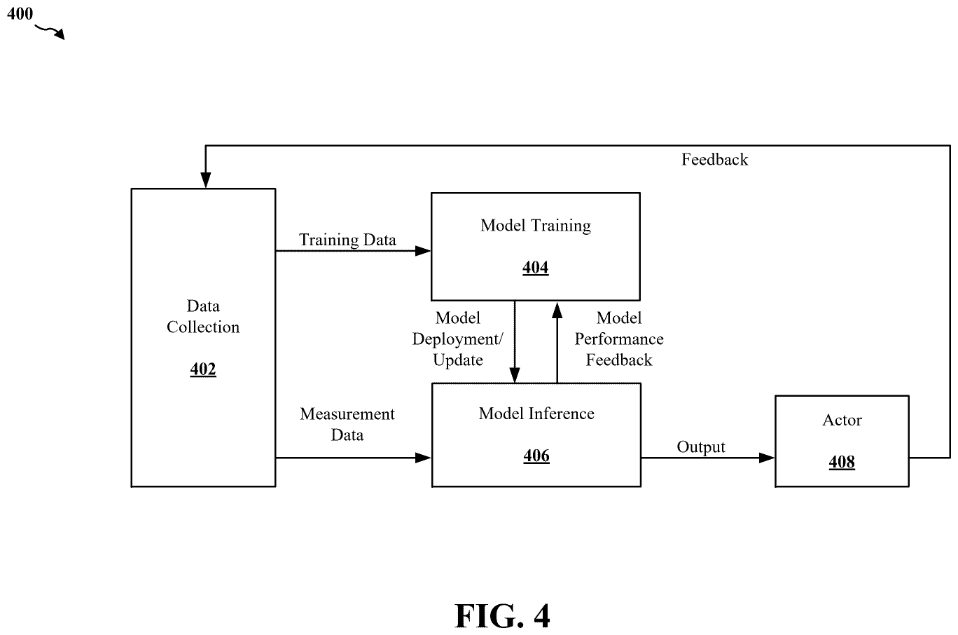

FIG. 4 is an example of the AI/ML algorithm 400 of a method of wireless communication and illustrates various aspects model training, model inference, model feedback, and model update. The AI/ML algorithm 400 may include various functions including a data collection 402, a model training function 404, a model inference function 406, and an actor 408.

The data collection 402 may be a function that provides input data to the model training function 404 and the model inference function 406. The data collection 402 function may include any form of data preparation, and it may not be specific to the implementation of the AI/ML algorithm (e.g., data pre-processing and cleaning, formatting, and transformation).

The examples of input data may include, but are not limited to, measurements, such as RSRP measurements, channel measurements, or other uplink/downlink transmissions, from entities including UEs or network nodes, feedback from the actor 408 (e.g., which may be a UE or network node), output from another AI/ML model. The data collection 402 may include training data, which refers to the data to be sent as the input for the AI/ML model training function 404, and inference data, which refers to be sent as the input for the AI/ML model inference function 406.

The model training function 404 may be a function that performs the ML model training, validation, and testing, which may generate model performance metrics as part of the model testing procedure. The model training function 404 may also be responsible for data preparation (e.g., data pre-processing and cleaning, formatting, and transformation) based on the training data delivered or received from the data collection 402 function. The model training function 404 may deploy or update a trained, validated, and tested AI/ML model to the model inference function 406, and receive a model performance feedback from the model inference function 406. As described above, there may be various functionalities to be performed by an AI/ML model for wireless communication

The model inference function 406 may be a function that provides the AI/ML model inference output (e.g., predictions or decisions). The model inference function 406 may also perform data preparation (e.g., data pre-processing and cleaning, formatting, and transformation) based on the inference data delivered from the data collection 402 function. The output of the model inference function 406 may include the inference output of the AI/ML model produced by the model inference function 406. The details of the inference output may be use case specific. As an example, the output may include a beam prediction for beam management. The prediction may be for the network or may be for the UE. In some aspects, the actor may be a component of the base station or of a core network. In other aspects, the actor may be a UE in communication with a wireless network.

The model performance feedback may refer to information derived from the model inference function 406 that may be suitable for the improvement of the AI/ML model trained in the model training function 404. The feedback from the actor 408 or other network entities (via the data collection 402 function) may be implemented for the model inference function 406 to create the model performance feedback.

The actor 408 may be a function that receives the output from the model inference function 406 and triggers or performs corresponding actions. The actor may trigger actions directed to network entities including the other network entities or itself. The actor 408 may also provide a feedback information that the model training function 404 or the model interference function 406 to derive training or inference data or performance feedback. The feedback may be transmitted back to the data collection 402.

The network may use machine-learning algorithms, deep-learning algorithms, neural networks, reinforcement learning, regression, boosting, or advanced signal processing methods for aspects of wireless communication including the various functionalities such as beam management, CSF, or positioning, among other examples.

In some aspects described herein, the network may train one or more neural networks to learn the dependence of measured qualities on individual parameters. Among others, examples of machine learning models or neural networks that may be included in the network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by the concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., any feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at the last layer of the neural network and may traverse layers multiple times.

In some instances, beam correspondence, for some UEs, may comprise different components, such as, for example UE minimum peak EIRP, UE spherical coverage, and beam correspondence tolerance. Beam correspondence may be fulfilled in instances where a UE satisfies certain conditions, based at least on the beam correspondence capability of the UE (e.g., a beam correspondence without UL beam sweeping, which may be referred to in some aspects as “beamCorrespondenceWithoutUL-BeamSweeping”). In some instances, if the beam correspondence capability of the UE supports beamCorrespondenceWithoutUL-BeamSweeping, then the UE may meet the minimum peak EIRP and spherical coverage conditions with uplink beams being autonomously chosen without using uplink beam sweeping. In such instances, such a UE supports beam correspondence. In some instances, if the beam correspondence capability of the UE supports beamCorrespondenceWithoutUL-BeamSweeping and beamCorrespondenceSSB-based-r16 (e.g., UE has the ability to select an uplink beam based on measurement of SSB), then the UE may meet the minimum peak EIRP and spherical coverage conditions based on SSB based enhanced beam correspondence. In some instances, if the beam correspondence capability of the UE supports beamCorrespondenceWithoutUL-BeamSweeping and beamCorrespondenceSSB-based-r16, then the UE may meet the minimum peak EIRP and spherical coverage conditions based on CSI-RS based enhanced beam correspondence. In some instances, if the beam correspondence capability of the UE does not support beamCorrespondenceWithoutUL-BeamSweeping, the UE may meet the minimum peak EIRP and spherical coverage conditions utilizing uplink beam sweeping. In such instances, such a UE may support beam correspondence and support uplink beam management. In some instances, if the beam correspondence capability of the UE does not support beamCorrespondenceWithoutUL-BeamSweeping while beamCorrespondenceSSB-based-r16 is supported, the UE may meet the minimum peak EIRP and spherical coverage conditions utilizing uplink beam sweeping based on SSB based enhanced beam correspondence. In such instances, such a UE may support beam correspondence and support uplink beam management. In some instances, if the beam correspondence capability of the UE does not support beamCorrespondenceWithoutUL-BeamSweeping while beamCorrespondenceSSB-based-r16 is supported, the UE may meet the minimum peak EIRP and spherical coverage conditions utilizing uplink beam sweeping based on CSI-RS based enhanced beam correspondence. In such instances, such a UE may support beam correspondence and support uplink beam management.

Beam correspondence may be applied in different instances. For example, in instances where the downlink reference signals include both SSB and CSI-RS are provided and Type D quasi co-location is to be maintained between the SSB and CSI-RS. Beam correspondence may be applied in instances where a reference measurement channel for beam correspondence is fulfilled based on a CSI-RS configuration. In some aspects, Layer 1 (L1) RSRP measurements may be based on Table 2, shown below.

TABLE 2

| | NR | Minimum SSB_RP | |
|---|---|---|---|
| Angle of | operating | dBm/SCS_{SSB} | SSB Ês/Iot |
| arrival | bands | SCS_{SSB} = 120 kHz | dB |
| All angles | n257 | −96.2 | ≥6 |
| | n258 | −96.2 | |
| | n259 | −90.7 | |
| | n260 | −91.9 | |
| | n261 | −96.2 | |
| | n262 | −88.5 | |

For UEs that support multiple FR2 bands, the Minimum SSB_RP values for all angles are increased by ΔMB_{S, n}, the UE multi-band relaxation factor in dB.
Values specified at the radiated requirements reference point to give minimum SSB Ês/Iot, with no applied noise.

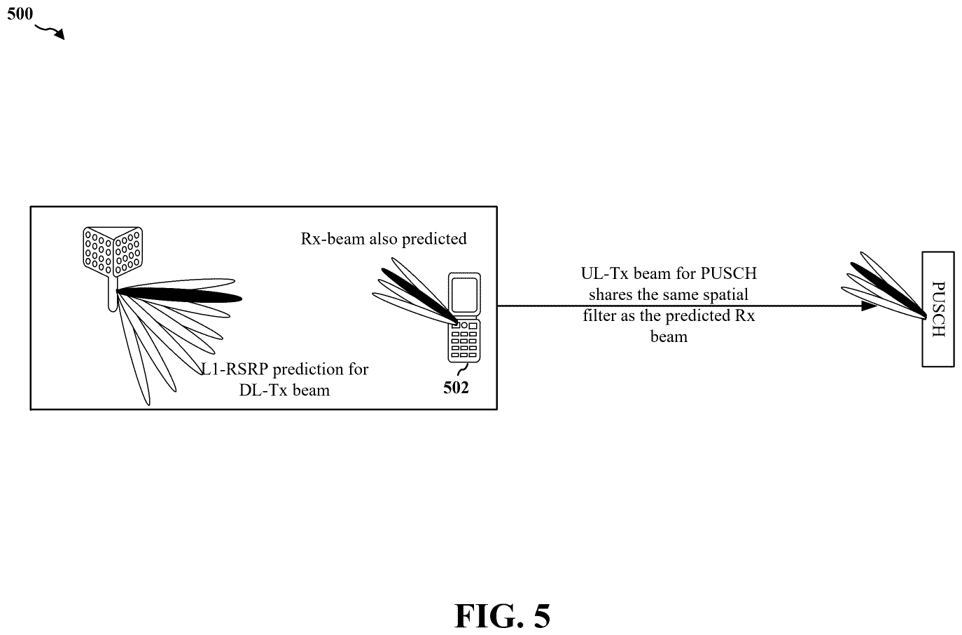

FIG. 5 provides an example diagram 500 of beam prediction for an uplink transmission beam. In the diagram 500 of FIG. 5, the UE 502 may support beam correspondence. In such instances, when predicting L1 RSRP for downlink beams, the associated receive beam may also be predicted by the UE, which may then be used for uplink transmission (e.g., PUSCH) in instances where the UE has beam correspondence.

In some instances, it may be assumed that a UE has an acceptable prediction accuracy for predicting a downlink transmission beam's L1 RSRP, such that a beam correspondence may be associated with uplink transmission beams that are determined based on predicted downlink transmission beams. However, the prediction accuracy for downlink transmission beams may be unreliable.

Aspects presented herein provide a configuration for confidence levels associated for beam correspondence for uplink transmission beam predictions. For example, beam correspondence may be supported in instances where uplink transmission beam predictions are carried out regardless a prediction accuracy for L1 RSRP of a downlink transmission beam. In addition, a UE may autonomously predict uplink transmission beams with respect to a number of prediction cycles, based on previous measurements of downlink transmission beams during measurement cycles. Confidence levels may be associated with beam correspondence based on the uplink transmission beam prediction framework. Such confidence levels may be based on the measured or predicted uplink transmission beams of the uplink transmission beam prediction framework. At least one advantage of the disclosure is the decoupling of the downlink transmission beam prediction accuracy with beam correspondence for uplink transmission beam predictions.

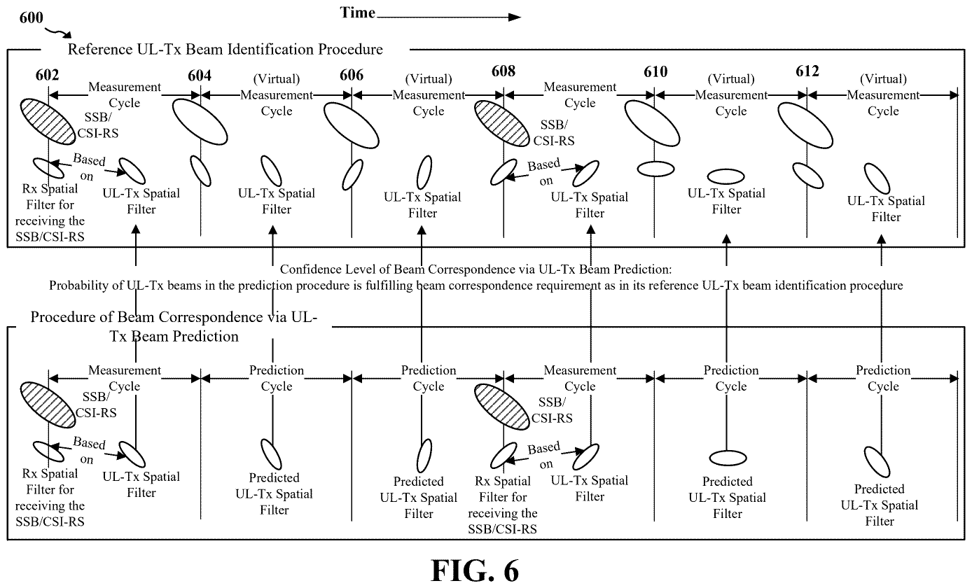

FIG. 6 provides a diagram 600 of an uplink transmission beam identification procedure and a beam correspondence procedure. In some instances, the UE may perform downlink measurements (e.g., at instances 602 and 608), while in other instances (e.g., at instances 604, 606, 610, and 612), the UE does not perform downlink measurements. In FIG. 6, these instances are labeled as virtual measurement cycles, because the UE predicts the downlink beam without measuring the SSB or CSI-RS in the cycle. For instances 602 and 608, the UE measures the SSB/CSI-RS and determines a reception filter for receiving the SSB/CSI-RS, which may be referred to as a downlink beam or Rx beam. The UE may then determine a corresponding uplink transmission spatial filter, which may be referred to as an uplink beam or transmission beam. In instances where the UE does not perform downlink measurements, the UE may predict downlink beams for prediction cycles. For those predictions, the UE may also identify the corresponding uplink transmission beam based on the predicted downlink beam. A reference procedure may be defined for the UE. In the reference procedure, the UE may measure downlink beams and then determine the uplink transmission beam based on the receive beam identified for the downlink beam. An error tolerance between an uplink transmission spatial filter and a predicted uplink transmission spatial filter may be determined to specify a beam prediction based on the beam correspondence. For example, if a difference between an uplink transmission spatial filter and a predicted uplink transmission spatial filter is within a threshold, based on a comparison of their respective peak point directions, then the UE may meet the requirement for the beam correspondence based on downlink beam prediction.

In some instances, beam correspondence may be supported based on a set of confidence levels, e.g., one or more confidence levels from the set of confidence levels. The set of confidence levels for beam correspondence may be for on an uplink transmission beam prediction procedure. In some aspects, a set of confidence levels may be defined (e.g. defined in a wireless standard or otherwise known in advance by the UE and network) for beam correspondence based on the uplink transmission beam prediction. A UE may report one or more UE capabilities associated with the set of confidence levels for beam correspondence based on the uplink transmission beam prediction. In some instances, the report of the one or more UE capabilities may be based on, e.g., provided in, a UE RRC capability report during an initial access, or may be based on, e.g., provided in, dynamic updates, such as, MAC-CE or UCI.

In some instances, the set of confidence levels for beam correspondence based on the uplink transmission beam prediction may be based on a probability of the beam correspondence being fulfilled based on uplink transmission beam prediction with inputs being time domain down-sampled downlink beam measurements, e.g., with downlink beam predictions as opposed to being based on downlink beam measurements.

In some aspects, for beam correspondence based on the uplink transmission beam prediction, the UE may be configured or indicated with at least one SSB resource or a non-zero power channel state information reference signal (NZP-CSI-RS) that may be dedicated for such beam correspondence based on the uplink transmission beam prediction. In some aspects, the SSB or the NZP-CSI-RS may maintain a same transmit spatial filter across different transmission occasions, such that the uplink transmission beam prediction becomes more traceable. The UE may be configured to measure the SSB or the NZP-CSI-RS within a periodicity P₁. The transmission periodicity of the SSB or the NZP-CSI-RS may be less than the periodicity P₁. The UE may comprise measurement cycles that meet beam correspondence at the time where the SSB or the NZP-CSI-RS is measured. For example, the UE may use an uplink transmission spatial filter based on the downlink receive spatial filter to receive the SSB or NZP-CSI-RS at the measurement occasions. The UE prediction cycles may occur after a first SSB or NZP-CSI-RS measurement occasion with respect to the base station (e.g., network) configured or indicated SSB or NZP-CSI-RS. The UE may predict uplink transmission beams with a periodicity P₂, where P₂<P₁, until a second or subsequent SSB or NZP-CSI-RS measurement occasion with respect to the base station (e.g., network) configured or indicated SSB or NZP-CSI-RS. In some aspects, the periodicity P₁ may be based on a factor of P₂, such that P₁=2P₂, 4P₂, 6P₂, etc.

A confidence level for beam correspondence may be based on a probability of beam correspondence being supported among the measurement and prediction cycles, which may be further associated with a reference uplink transmission beam identification procedure. In some aspects, during prediction cycles with respect to the reference uplink transmission beam identification procedure, the UE may be able to measure SSB or CSI-RS configured or indicated by the network. For the reference uplink transmission beam identification procedure, the UE may identify its uplink transmission spatial filter, based on the downlink reception spatial filter for receiving the SSB or NZP-CSI-RS, during the measurement cycle and/or the prediction cycle. The UE may meet beam correspondence for the uplink transmission beam identified using such a reference uplink transmission beam identification procedure.

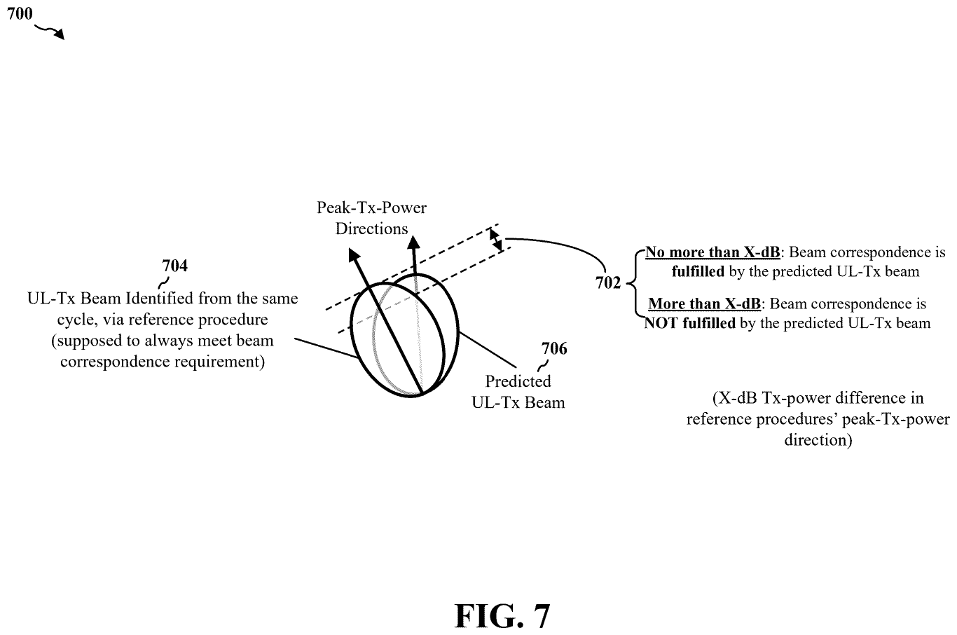

Beam correspondence may be fulfilled during a prediction cycle for beam correspondence based on the uplink transmission beam prediction. For example, in some aspects, the uplink transmission beam's radiated power of the beam correspondence via uplink beam prediction procedure, at the peak transmission power direction of the uplink transmission beam 704 identified via the reference uplink transmission beam identification procedure, may not be degraded by no more than a certain value in comparison to the uplink transmission beams' radiated power of the reference uplink transmission beam identification procedure at its peak transmission power direction, as shown for example in diagram 700 of FIG. 7. In some aspects, the value of X 702 may be configurable or predefined. In some aspects, the comparison may be defined at the direction of the peak-power direction of the predicted beam 706. In some aspects, the UE may meet the minimum peak EIRP and spherical coverage conditions with the predicted uplink transmission beam without measuring an SSB or NZP-CSI-RS.

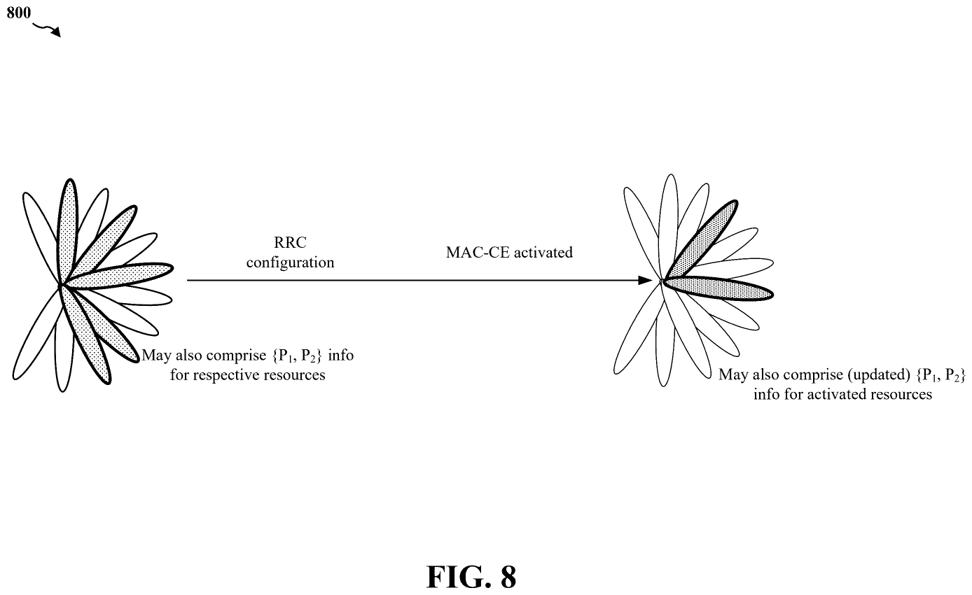

In some aspects, to identify the configured or indicated SSB or NZP-CSI-RS for beam correspondence via the uplink beam prediction procedure, the base station may provide to the UE a first number of downlink resources (e.g., SSB or NZP-CSI-RS) that should be used by the UE to identify beam correspondence based uplink transmission beams. The network (e.g., base station) may provide the first number of downlink resources via RRC signaling. In such instances, the RRC configuration may further comprise a value of P₁, P₂ or a ratio of P₁/P₂, as shown, for example in diagram 800 of FIG. 8. In some instances, the value of P₁ may be preconfigured such that P₁ is equal to the transmission periodicity of the downlink resources (e.g., SSB or NZP-CSI-RS). The network may update the RRC configured downlink resources (e.g., SSB or NZP-CSI-RS) and/or P₁, P₂ information with respect to certain downlink resources (e.g., SSB or NZP-CSI-RS), as shown for example in diagram 800 of FIG. 8. The network may update the RRC configured downlink resources (e.g., SSB or NZP-CSI-RS) and/or P₁, P₂ information via DCI or MAC-CE.

In some aspects, a MAC-CE may be utilized to activate a second set out of the RRC configured first set of downlink resources (e.g., SSB or NZP-CSI-RS) where the UE may use the activated downlink resources to identify predicted uplink transmission beam. In such instances, the MAC-CE may indicate the value of P₁, P₂ or the ratio of P₁/P₂. In some aspects, the value of P₁ may be preconfigured and may be equal to the transmission periodicity of the downlink resources (e.g., SSB or NZP-CSI-RS).

The UE behavior, when switched to a TCI state for SRS, PUCCH, or PUSCH whose source reference signal is one of the network configured or indicated downlink resources (e.g., SSB or NZP-CSI-RS), may depend on whether the SRS, PUCCH, or PUSCH is scheduled during the measurement cycles or prediction cycles associated with the procedure of beam correspondence via uplink transmission beam prediction based on the network configured or indicated downlink resources. The UE may utilize an uplink transmission beam identified in at least one of the measurement cycles or the prediction cycles. UE is not expected to use the predicted uplink transmission beams, when switched to a TCI state for SRS, PUCCH, or PUSCH whose resource reference signal is not one of the network configured or indicated downlink resources.

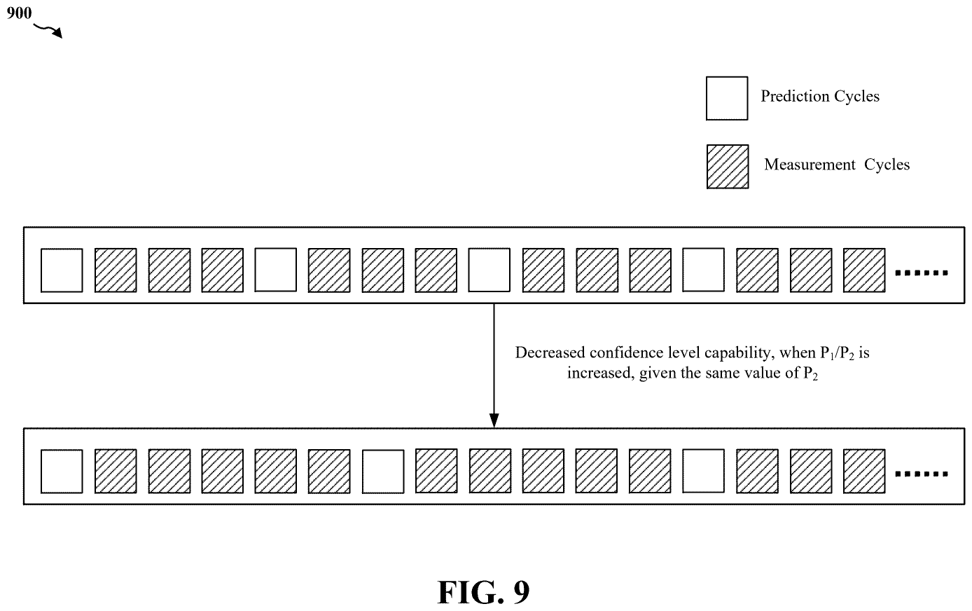

In some aspects, the UE may report its capability as combination(s) of a subset of one or more components based on conditions defined by the combination(s) of another subset of the components. For example, the UE may report a minimum L1 RSRP received from the network configured or indicated downlink resources (e.g., SSB or NZP-CSI-RS) for beam correspondence via UL beam prediction. The UE may report an association between P₁ and P₂, such as but not limited to, a maximum or minimum ratio of P₁/P₂, a maximum or minimum ratio of P₁/P₂ for a certain value of P₁ or P₂, or a maximum or minimum value of P₁ or P₂ for a certain ratio of P₁/P₂. The UE may report a maximum or minimum achievable confidence level of beam correspondence via uplink transmission beam prediction, such that a confidence level value may be quantized based on a percentage defined probability. For example, if L1-RSRP>−95 dBm, {P₁, P₂}={12, 2} ms, and may comprise a candidate capability options on {maximum, minimum} confidence levels of: {75%, 85%}, {80%, 90%}, {85%, 95%}. A decreased confidence level capability may occur when P₁/P₂ is increased, given the same value of P₂, as shown for example in diagram 900 of FIG. 9. In another example, if L1-RSRP>−95 dBm, {P₁, P2}={8,2} ms, and may comprise a candidate capability options on {maximum, minimum} confidence levels of: {80%, 90%}, {85%, 95%}, {87%, 97%}, {92%, 97%}. In another example, if L1-RSRP>−85 dBm, {P₁, P2}={8, 2} ms, and may comprise a candidate capability options on {maximum, minimum} confidence levels of: {85%, 95%}, {87%, 97%}, {92%, 97%}, {95%, 95%}. These values are merely examples and the disclosure is not intended to be limited to the examples disclosed herein.

In some aspects, the UE may report a maximum number of RRC configurable or MAC-CE activated downlink resources (e.g., SSB or NZP-CSI-RS) for beam correspondence via uplink transmission beam prediction. This can be further based on reporting different capabilities for different combination values of a certain subset from the components discussed above. For example, if {P₁, P₂}={12, 2} ms, then the candidate capability options on a maximum number of MAC-CE activated downlink resources (e.g., SSB or NZP-CSI-RS) is: 4, 8, 16. In another example, if {P₁, P₂}={8, 2} ms, then the candidate capability options on a maximum number of MAC-CE activated downlink resources (e.g., SSB or NZP-CSI-RS) is: 2, 4, 8. A more complex AI/ML algorithm may be utilized in instances where P1/P2 is increased, given the same value of P2, while a reduced number of downlink resources (e.g., SSB or CSI-RS) may be simultaneously activated via MAC-CE. The values provided herein are merely examples and the disclosure is not intended to be limited to the examples disclosed herein. In some aspects, the UE may report a first total maximum number across the downlink resources (e.g., SSB or NZP-CSI-RS) and a second total maximum number for SSBs, and/or a third total maximum number of CSI-RSs, where the final RRC configuration or MAC-CE activation does not violate any of the first, second, or third total maximum numbers.

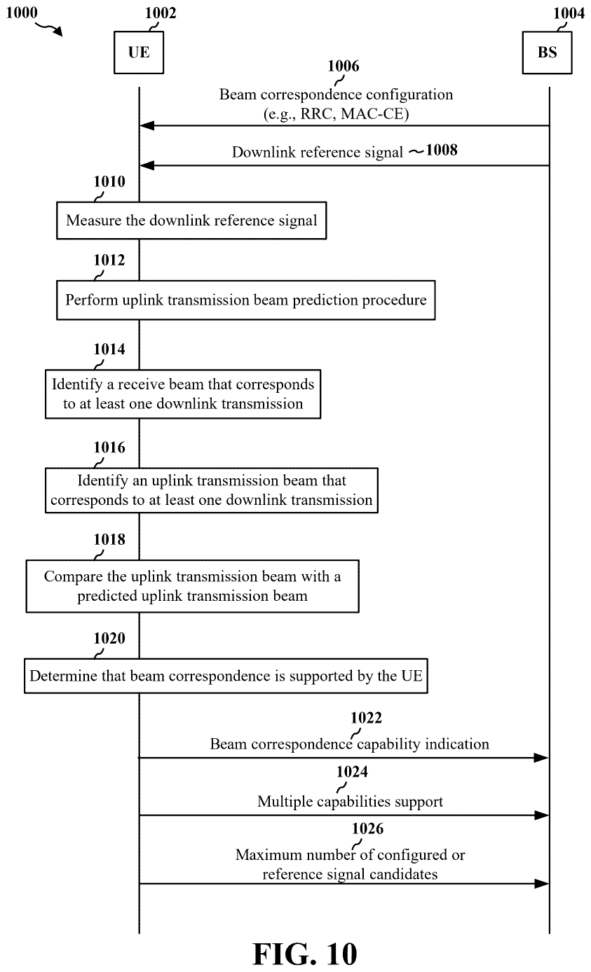

FIG. 10 is a call flow diagram 1000 of signaling between a UE 1002 and a base station 1004. The base station 1004 may be configured to provide at least one cell. The UE 1002 may be configured to communicate with the base station 1004. For example, in the context of FIG. 1, the base station 1004 may correspond to base station 102 and the UE 1002 may correspond to at least UE 104. In another example, in the context of FIG. 3, the base station 1004 may correspond to base station 310 and the UE 1002 may correspond to UE 350. Although the example is described for a base station 1004, the aspects may be performed by a base station in aggregation or may be performed by one or more components of a base station or network node, such as a CU 110, DU 130, or DU 140.

At 1006, the base station 1004 may provide a beam correspondence configuration, as shown in connection with any of FIGS. 6-9. The base station 1004 may provide the beam correspondence configuration to the UE 1002. The UE 1002 may receive the beam correspondence configuration from the base station 1004. The beam correspondence configuration may indicate at least one of a first periodicity for a measurement cycle or a second periodicity for a prediction cycle comprising resources allocated for the UE to determine whether the beam correspondence is supported. The beam correspondence configuration is provided via at least one of RRC signaling or MAC-CE.

At 1008, the base station 1004 may provide at least one downlink transmission, as shown in connection with any of FIGS. 6-9. The base station may provide the at least one downlink transmission to the UE 1002. The UE 1002 may receive the at least one downlink transmission from the base station 1004. The base station may provide the at least one downlink transmission such that the UE may perform an uplink transmission beam prediction procedure based on the at least one downlink transmission. The at least one downlink transmission may comprise a configuration of a downlink reference signal for a beam correspondence.

At 1010, the UE 1002 may measure the downlink reference signal within a measurement cycle having a first periodicity, as shown in connection with any of FIGS. 6-9. The UE may perform the uplink transmission beam prediction procedure based on a prediction cycle that has a second periodicity that may be less than the first periodicity of the measurement cycle for the downlink reference signal. In some aspects, the downlink reference signal may comprise a third periodicity that may be less than the first periodicity of the measurement cycle. The downlink reference signal may include at least one of a synchronization SSB resource for the beam correspondence via the uplink transmission beam prediction procedure, a periodic NZP-CSI-RS resource for the beam correspondence via the uplink transmission beam prediction procedure, or a semi-persistent NZP-CSI-RS resource dedicated for the beam correspondence for the beam correspondence via the uplink transmission beam prediction procedure. In some aspects, a comparison of the predicted uplink transmission beam may be based on a receive beam that corresponds to the downlink reference signal with the predicted uplink transmission beam occurs within the measurement cycle of the downlink reference signal. An uplink transmission spatial filter based on a downlink reception spatial filter may be utilized to receive the at least one downlink transmission at measurement occasions. In some aspects, the uplink transmission beam prediction procedure may occur within the prediction cycle after the measurement cycle of the downlink reference signal. In some aspects, the set of confidence levels for the beam correspondence may be based on the predicted uplink transmission beam, within the prediction cycle, having a radiated power at a peak transmission power direction that meets a threshold in comparison to a reference uplink transmission beam. The threshold may be based on at least one of a comparison to the reference uplink transmission beam, a direction of the peak transmission power direction of the predicted uplink transmission beam, or at least one of a minimum peak equivalent isotropic radiated power (EIRP) or a spherical coverage for the predicted uplink transmission beam. In some aspects, the UE may identify an uplink transmission spatial filter based on a downlink reception spatial filter to receive the at least one downlink transmission. In some aspects, the beam correspondence capability may be based on at least one of a minimum L1 RSRP measured for the downlink reference signal, an association between the first periodicity of the measurement cycle and the second periodicity for the prediction cycle, or a maximum or minimum achievable confidence level of the beam correspondence based on the uplink transmission beam prediction procedure.

At 1012, the UE 1002 may perform the uplink transmission beam prediction procedure, as shown in connection with any of FIGS. 6-9. The UE may perform the uplink transmission beam prediction procedure based on at least one downlink transmission. A predicted uplink transmission beam may be selected based on a set of confidence levels for a beam correspondence.

At 1014, the UE 1002 may identify a receive beam that corresponds to the at least one downlink transmission, as shown in connection with any of FIGS. 6-9.

At 1016, the UE 1002 may identify an uplink transmission beam, as shown in connection with any of FIGS. 6-9. The UE may identify the uplink transmission beam based on the receive beam, identified by the UE, that corresponds to the at least one downlink transmission.

At 1018, the UE 1002 may compare the uplink transmission beam based on the receive beam that corresponds to the at least one downlink transmission with the predicted uplink transmission beam based on the uplink transmission beam prediction procedure, as shown in connection with any of FIGS. 6-9. In some aspects, a comparison of the uplink transmission beam and the predicted uplink transmission beam may be performed to obtain a variance measurement. The results of the variance measurement may be referenced with one or more thresholds for the beam correspondence to determine whether the beam correspondence is supported by the UE. Beam correspondence is supported by the UE in response to the results of the variance measurement being within the one or more thresholds for the beam correspondence.

At 1020, the UE 1002 may determine that the beam correspondence is supported by the UE during the prediction cycle of the uplink transmission beam prediction procedure, as shown in connection with any of FIGS. 6-9. The UE may determine that the beam correspondence is supported by the UE during the prediction cycle of the uplink transmission beam prediction procedure based on at least on a transmission power difference between the predicted uplink transmission beam and an uplink beam based on measurement of the at least one downlink transmission.

At 1022, the UE 1002 may transmit an indication of support for a beam correspondence capability for the uplink transmission beam prediction procedure meeting at least one of the set of confidence levels for the beam correspondence, as shown in connection with any of FIGS. 6-9. The UE 1002 may transmit the indication of support for the beam correspondence capability to the base station 1004. The base station 1004 may obtain the indication of support for the beam correspondence capability from the UE 1002. In some aspects, the beam correspondence capability may be based on a probability of a beam correspondence level being fulfilled for the uplink transmission beam prediction procedure based on temporal down sampled downlink beam measurements. The beam correspondence capability may be for the uplink transmission beam prediction procedure based on a machine learning prediction for a downlink beam.

At 1024, the UE 1002, in some aspects, may report the support for multiple capabilities associated with the set of confidence levels for the beam correspondence, as shown in connection with any of FIGS. 6-9. The UE 1002 may transmit the report of support for the multiple capabilities associated with the set of confidence levels for the beam correspondence to the base station 1004. The base station may obtain the report of support for the multiple capabilities associated with the set of confidence levels for the beam correspondence from the UE 1002. The support for multiple capabilities associated with the set of confidence levels for the beam correspondence may be reported in at least one of a UE RRC capability during initial access, a MAC-CE, or UCI.

At 1026, the UE 1002, in some aspects, may indicate support for a maximum number of configured or reference signal candidates, as shown in connection with any of FIGS. 6-9. For example, the UE may indicate support for at least one of a first maximum number of configured reference signal candidates that the UE supports for the uplink transmission beam prediction procedure, or a second maximum number of activated reference signal candidates that the UE supports for the uplink transmission beam prediction procedure. The UE may transmit an indication for support for the maximum number of configured or reference signal candidates to the base station 1004. The base station 1004 may obtain the indication for support for the maximum number of configured or reference signal candidates from the UE 1002.

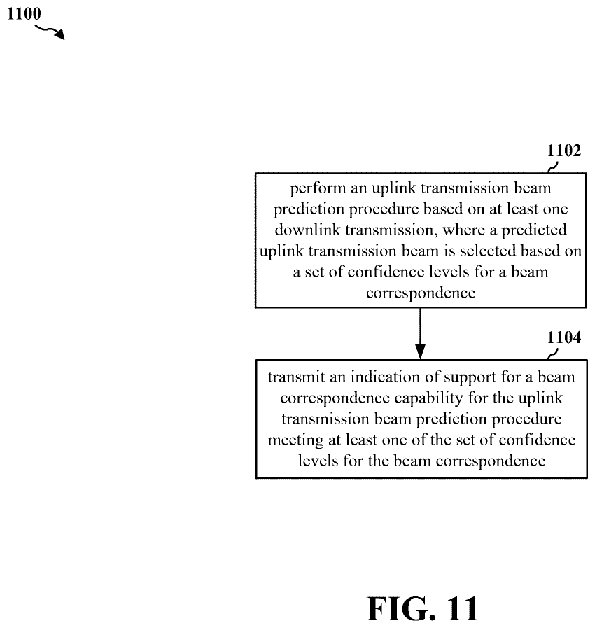

FIG. 11 is a flowchart 1100 of a method of wireless communication. The method may be performed by a UE (e.g., the UE 104; the apparatus 1304). One or more of the illustrated operations may be omitted, transposed, or contemporaneous. The method may allow a UE to predict an uplink transmission beam based on a set of confidence levels for a beam correspondence.

At 1102, the UE may perform an uplink transmission beam prediction procedure, as shown in connection with any of FIGS. 6-9. For example, 1102 may be performed by prediction component 198 of apparatus 1304. The UE may perform the uplink transmission beam prediction procedure based on at least one downlink transmission. A predicted uplink transmission beam may be selected based on a set of confidence levels for a beam correspondence.

At 1104, the UE may transmit an indication of support for a beam correspondence capability for the uplink transmission beam prediction procedure meeting at least one of the set of confidence levels for the beam correspondence, as shown in connection with any of FIGS. 6-9. For example, 1104 may be performed by prediction component 198 of apparatus 1304. In some aspects, the beam correspondence capability may be based on a probability of a beam correspondence level being fulfilled for the uplink transmission beam prediction procedure based on temporal down sampled downlink beam measurements. The beam correspondence capability may be for the uplink transmission beam prediction procedure based on a machine learning prediction for a downlink beam.

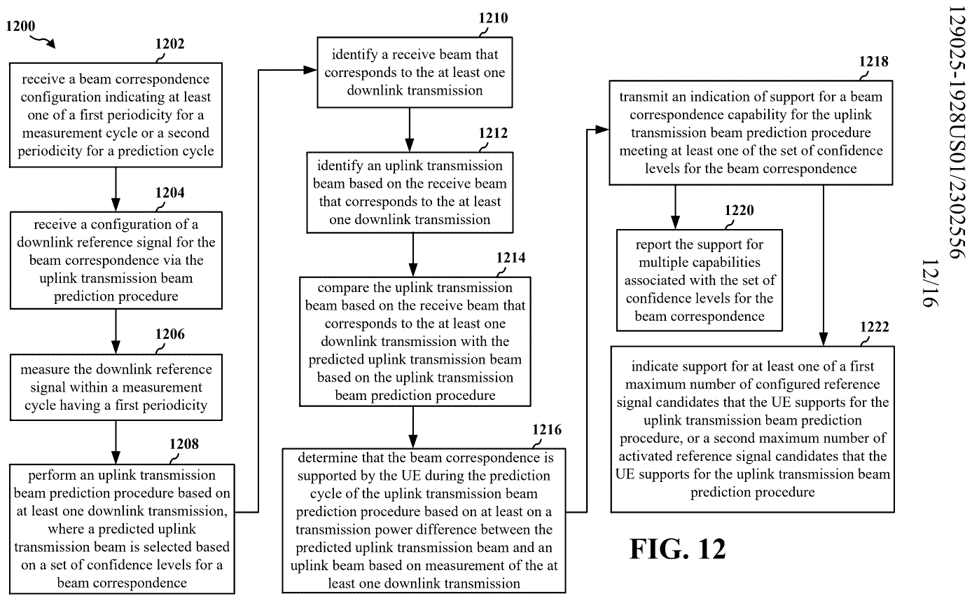

FIG. 12 is a flowchart 1200 of a method of wireless communication. The method may be performed by a UE (e.g., the UE 104; the apparatus 1304). One or more of the illustrated operations may be omitted, transposed, or contemporaneous. The method may allow a UE to predict an uplink transmission beam based on a set of confidence levels for a beam correspondence.

At 1202, the UE may receive a beam correspondence configuration, as shown in connection with any of FIGS. 6-9. For example, 1202 may be performed by prediction component 198 of apparatus 1304. The beam correspondence configuration may indicate at least one of the first periodicity for the measurement cycle or the second periodicity for the prediction cycle comprising resources allocated for the UE to determine whether the beam correspondence is supported. The beam correspondence configuration may be received via at least one of RRC signaling or a medium access control (MAC) control element (CE) (MAC-CE).

At 1204, the UE may receive a configuration of a downlink reference signal for the beam correspondence, as shown in connection with any of FIGS. 6-9. For example, 1204 may be performed by prediction component 198 of apparatus 1304. The UE may receive the configuration of the downlink reference signal for the beam correspondence via an uplink transmission beam prediction procedure.

At 1206, the UE may measure the downlink reference signal within a measurement cycle having a first periodicity, as shown in connection with any of FIGS. 6-9. For example, 1206 may be performed by prediction component 198 of apparatus 1304. The UE may perform the uplink transmission beam prediction procedure based on a prediction cycle that has a second periodicity that may be less than the first periodicity of the measurement cycle for the downlink reference signal. In some aspects, the downlink reference signal may comprise a third periodicity that may be less than the first periodicity of the measurement cycle. The downlink reference signal may include at least one of a SSB resource for the beam correspondence via the uplink transmission beam prediction procedure, a periodic NZP-CSI-RS resource for the beam correspondence via the uplink transmission beam prediction procedure, or a semi-persistent NZP-CSI-RS resource dedicated for the beam correspondence for the beam correspondence via the uplink transmission beam prediction procedure. In some aspects, a comparison of the predicted uplink transmission beam may be based on a receive beam that corresponds to the downlink reference signal with the predicted uplink transmission beam occurs within the measurement cycle of the downlink reference signal. An uplink transmission spatial filter based on a downlink reception spatial filter may be utilized to receive the at least one downlink transmission at measurement occasions. In some aspects, the uplink transmission beam prediction procedure may occur within the prediction cycle after the measurement cycle of the downlink reference signal. In some aspects, the set of confidence levels for the beam correspondence may be based on the predicted uplink transmission beam, within the prediction cycle, having a radiated power at a peak transmission power direction that meets a threshold in comparison to a reference uplink transmission beam. The threshold may be based on at least one of a comparison to the reference uplink transmission beam, a direction of the peak transmission power direction of the predicted uplink transmission beam, or at least one of a minimum peak EIRP or a spherical coverage for the predicted uplink transmission beam. In some aspects, the UE may identify an uplink transmission spatial filter based on a downlink reception spatial filter to receive the at least one downlink transmission. In some aspects, the beam correspondence capability may be based on at least one of a minimum L1 RSRP measured for the downlink reference signal, an association between the first periodicity of the measurement cycle and the second periodicity for the prediction cycle, or a maximum or minimum achievable confidence level of the beam correspondence based on the uplink transmission beam prediction procedure.

At 1208, the UE may perform an uplink transmission beam prediction procedure, as shown in connection with any of FIGS. 6-9. For example, 1208 may be performed by prediction component 198 of apparatus 1304. The UE may perform the uplink transmission beam prediction procedure based on at least one downlink transmission. A predicted uplink transmission beam may be selected based on a set of confidence levels for a beam correspondence.

At 1210, the UE may identify a receive beam that corresponds to the at least one downlink transmission, as shown in connection with any of FIGS. 6-9. For example, 1210 may be performed by prediction component 198 of apparatus 1304.

At 1212, the UE may identify an uplink transmission beam, as shown in connection with any of FIGS. 6-9. For example, 1212 may be performed by prediction component 198 of apparatus 1304. The UE may identify the uplink transmission beam based on the receive beam that corresponds to the at least one downlink transmission.

At 1214, the UE may compare the uplink transmission beam based on the receive beam that corresponds to the at least one downlink transmission with the predicted uplink transmission beam based on the uplink transmission beam prediction procedure, as shown in connection with any of FIGS. 6-9. For example, 1214 may be performed by prediction component 198 of apparatus 1304. In some aspects, a comparison of the uplink transmission beam and the predicted uplink transmission beam may be performed to obtain a variance measurement. The results of the variance measurement may be referenced with one or more thresholds for the beam correspondence to determine whether the beam correspondence is supported by the UE. Beam correspondence is supported by the UE in response to the results of the variance measurement being within the one or more thresholds for the beam correspondence.

At 1216, the UE may determine that the beam correspondence is supported by the UE during the prediction cycle of the uplink transmission beam prediction procedure, as shown in connection with any of FIGS. 6-9. For example, 1216 may be performed by prediction component 198 of apparatus 1304. The UE may determine that the beam correspondence is supported by the UE during the prediction cycle of the uplink transmission beam prediction procedure based on at least on a transmission power difference between the predicted uplink transmission beam and an uplink beam based on measurement of the at least one downlink transmission.

At 1218, the UE may transmit an indication of support for a beam correspondence capability for the uplink transmission beam prediction procedure meeting at least one of the set of confidence levels for the beam correspondence, as shown in connection with any of FIGS. 6-9. For example, 1218 may be performed by prediction component 198 of apparatus 1304. In some aspects, the beam correspondence capability may be based on a probability of a beam correspondence level being fulfilled for the uplink transmission beam prediction procedure based on temporal down sampled downlink beam measurements. The beam correspondence capability may be for the uplink transmission beam prediction procedure based on a machine learning prediction for a downlink beam.

At 1220, the UE, in some aspects, may report the support for multiple capabilities associated with the set of confidence levels for the beam correspondence, as shown in connection with any of FIGS. 6-9. For example, 1220 may be performed by prediction component 198 of apparatus 1304. The support for multiple capabilities associated with the set of confidence levels for the beam correspondence may be reported in at least one of a UE RRC capability during initial access, a MAC-CE, or UCI.

At 1222, the UE, in some aspects, may indicate support for at least one of a first maximum number of configured reference signal candidates that the UE supports for the uplink transmission beam prediction procedure, or a second maximum number of activated reference signal candidates that the UE supports for the uplink transmission beam prediction procedure, as shown in connection with any of FIGS. 6-9. For example, 1222 may be performed by prediction component 198 of apparatus 1304.

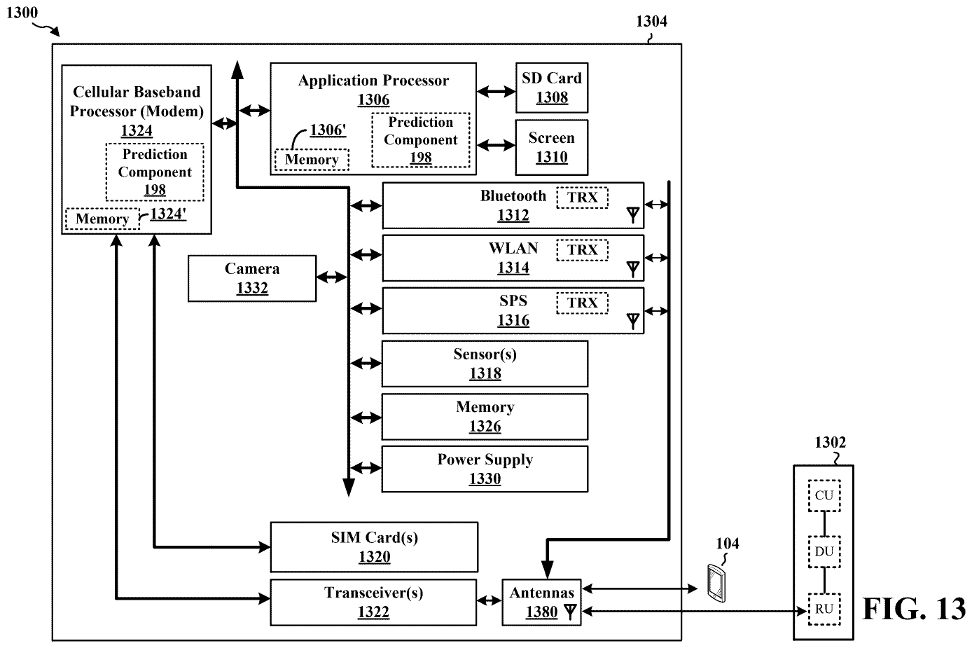

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the component 198 is configured to perform an uplink transmission beam prediction procedure based on at least one downlink transmission, wherein a predicted uplink transmission beam is selected based on a set of confidence levels for a beam correspondence; and transmit an indication of support for a beam correspondence capability for the uplink transmission beam prediction procedure meeting at least one of the set of confidence levels for the beam correspondence. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for performing an uplink transmission beam prediction procedure based on at least one downlink transmission. A predicted uplink transmission beam is selected based on a set of confidence levels for a beam correspondence. The apparatus includes means for transmitting an indication of support for a beam correspondence capability for the uplink transmission beam prediction procedure meeting at least one of the set of confidence levels for the beam correspondence. The apparatus further includes means for reporting the support for multiple capabilities associated with the set of confidence levels for the beam correspondence. The support is reported in at least one of a UE RRC capability during initial access, a MAC-CE, or UCI. The apparatus further includes means for identifying a receive beam that corresponds to the at least one downlink transmission. The apparatus further includes means for identifying an uplink transmission beam based on the receive beam that corresponds to the at least one downlink transmission. The apparatus further includes means for comparing the uplink transmission beam based on the receive beam that corresponds to the at least one downlink transmission with the predicted uplink transmission beam based on the uplink transmission beam prediction procedure. The apparatus further includes means for receiving a configuration of a downlink reference signal for the beam correspondence via the uplink transmission beam prediction procedure. The apparatus further includes means for measuring the downlink reference signal within a measurement cycle having a first periodicity. The UE performs the uplink transmission beam prediction procedure based on a prediction cycle that has a second periodicity that is less than the first periodicity of the measurement cycle for the downlink reference signal. The apparatus further includes means for determining that the beam correspondence is supported by the UE during the prediction cycle of the uplink transmission beam prediction procedure based on at least on a transmission power difference between the predicted uplink transmission beam and an uplink beam based on measurement of the at least one downlink transmission. The apparatus further includes means for receiving a beam correspondence configuration indicating at least one of the first periodicity for the measurement cycle or the second periodicity for the prediction cycle comprising resources allocated for the UE to determine whether the beam correspondence is supported. The beam correspondence configuration is received via at least one of RRC signaling or a MAC-CE. The apparatus further includes means for indicating support for at least one of a first maximum number of configured reference signal candidates that the UE supports for the uplink transmission beam prediction procedure, or a second maximum number of activated reference signal candidates that the UE supports for the uplink transmission beam prediction procedure. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

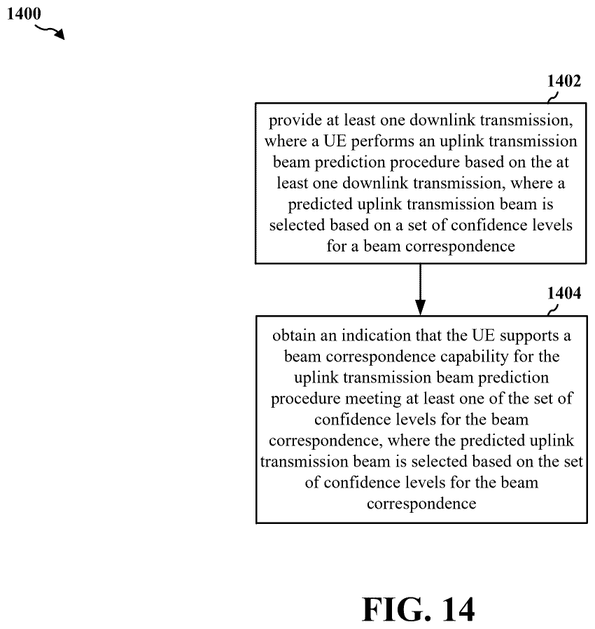

FIG. 14 is a flowchart 1400 of a method of wireless communication. The method may be performed by a base station (e.g., the base station 102; the network entity 1602. One or more of the illustrated operations may be omitted, transposed, or contemporaneous. The method may configure a UE to predict an uplink transmission beam based on a set of confidence levels for a beam correspondence.

At 1402, the network entity may provide at least one downlink transmission, as shown in connection with any of FIGS. 6-9. For example, 1402 may be performed by prediction component 199 of network entity 1602. The network entity may provide the at least one downlink transmission such that a UE may perform an uplink transmission beam prediction procedure based on the at least one downlink transmission.

At 1404, the network entity may obtain an indication that the UE supports a beam correspondence capability for the uplink transmission beam prediction procedure meeting at least one of the set of confidence levels for the beam correspondence, as shown in connection with any of FIGS. 6-9. For example, 1404 may be performed by prediction component 199 of network entity 1602. A predicted uplink transmission beam is selected based on the set of confidence levels for the beam correspondence. In some aspects, the set of confidence levels for the beam correspondence based on the predicted uplink transmission beam may be based on downlink beam measurements. In some aspects, the set of confidence levels for the beam correspondence are based on the predicted uplink transmission beam, within a prediction cycle, may have a radiated power at a peak transmission power direction that meets a threshold in comparison to a reference uplink transmission beam. The threshold is based on at least one of a comparison to the reference uplink transmission beam, a direction of the peak transmission power direction of the predicted uplink transmission beam, or at least one of a minimum peak EIRP or a spherical coverage for the predicted uplink transmission beam. The UE may identify an uplink transmission spatial filter based on a downlink reception spatial filter to receive the at least one downlink transmission. In some aspects, the beam correspondence capability may be based on at least one of a minimum layer 1 (L1) reference signal received power (RSRP) measured for a downlink reference signal, an association between a first periodicity of a measurement cycle and a second periodicity for a prediction cycle, or a maximum or minimum achievable confidence level of the beam correspondence based on the uplink transmission beam prediction procedure.

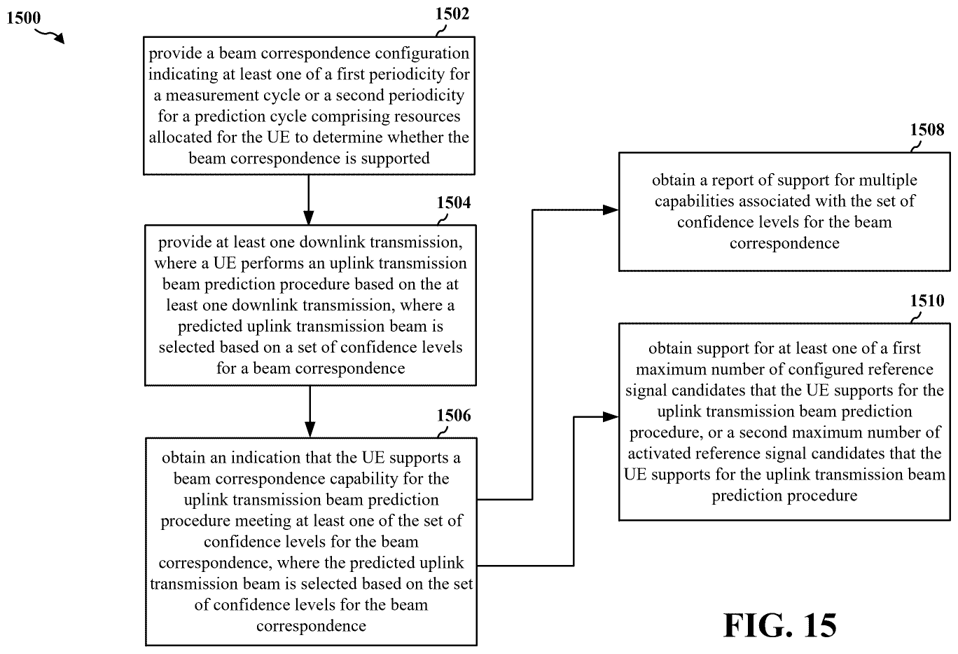

FIG. 15 is a flowchart 1500 of a method of wireless communication. The method may be performed by a base station (e.g., the base station 102; the network entity 1602. One or more of the illustrated operations may be omitted, transposed, or contemporaneous. The method may configure a UE to predict an uplink transmission beam based on a set of confidence levels for a beam correspondence.

At 1502, the network entity may provide a beam correspondence configuration, as shown in connection with any of FIGS. 6-9. For example, 1502 may be performed by prediction component 199 of network entity 1602. The beam correspondence configuration may indicate at least one of a first periodicity for a measurement cycle or a second periodicity for a prediction cycle comprising resources allocated for the UE to determine whether the beam correspondence is supported. The beam correspondence configuration is provided via at least one of RRC signaling or MAC-CE.

At 1504, the network entity may provide at least one downlink transmission, as shown in connection with any of FIGS. 6-9. For example, 1504 may be performed by prediction component 199 of network entity 1602. The network entity may provide the at least one downlink transmission such that a UE may perform an uplink transmission beam prediction procedure based on the at least one downlink transmission.

At 1506, the network entity may obtain an indication that the UE supports a beam correspondence capability for the uplink transmission beam prediction procedure meeting at least one of the set of confidence levels for the beam correspondence, as shown in connection with any of FIGS. 6-9. For example, 1506 may be performed by prediction component 199 of network entity 1602. A predicted uplink transmission beam is selected based on the set of confidence levels for the beam correspondence. In some aspects, the set of confidence levels for the beam correspondence based on the predicted uplink transmission beam may be based on downlink beam measurements. In some aspects, the set of confidence levels for the beam correspondence are based on the predicted uplink transmission beam, within a prediction cycle, may have a radiated power at a peak transmission power direction that meets a threshold in comparison to a reference uplink transmission beam. The threshold is based on at least one of a comparison to the reference uplink transmission beam, a direction of the peak transmission power direction of the predicted uplink transmission beam, or at least one of a minimum peak EIRP or a spherical coverage for the predicted uplink transmission beam. The UE may identify an uplink transmission spatial filter based on a downlink reception spatial filter to receive the at least one downlink transmission. In some aspects, the beam correspondence capability may be based on at least one of a minimum layer 1 (L1) reference signal received power (RSRP) measured for a downlink reference signal, an association between a first periodicity of a measurement cycle and a second periodicity for a prediction cycle, or a maximum or minimum achievable confidence level of the beam correspondence based on the uplink transmission beam prediction procedure.

At 1508, the network entity, in some aspects, may obtain a report of support for multiple capabilities associated with the set of confidence levels for the beam correspondence, as shown in connection with any of FIGS. 6-9. For example, 1508 may be performed by prediction component 199 of network entity 1602. The support for multiple capabilities associated with the set of confidence levels for the beam correspondence may be reported in at least one of a UE RRC capability during initial access, a MAC-CE, or UCI.

At 1510, the network entity, in some aspects, may obtain support for at least one of a first maximum number of configured reference signal candidates that the UE supports for the uplink transmission beam prediction procedure, or a second maximum number of activated reference signal candidates that the UE supports for the uplink transmission beam prediction procedure, as shown in connection with any of FIGS. 6-9. For example, 1510 may be performed by prediction component 199 of network entity 1602.

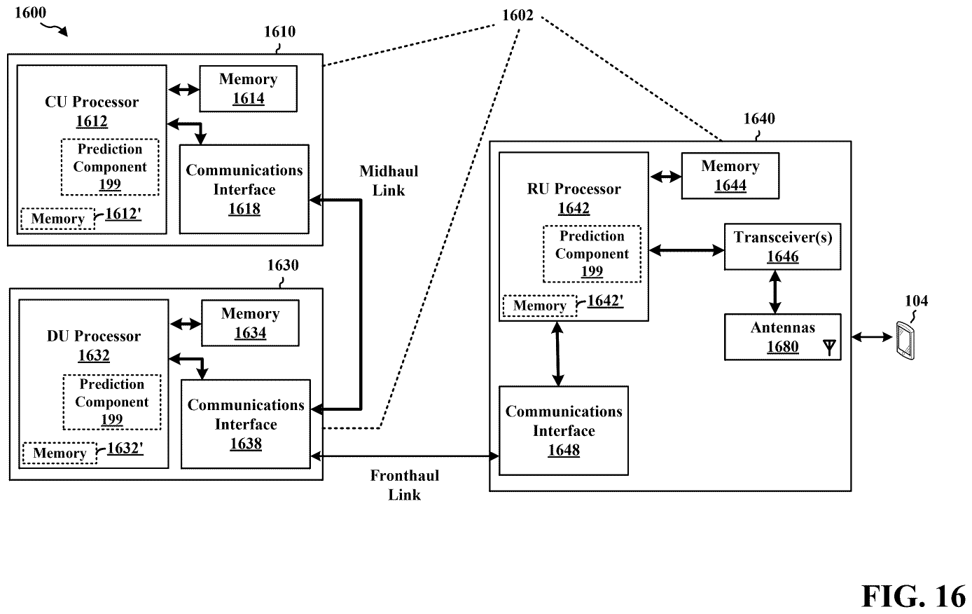

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to provide at least one downlink transmission, wherein a UE performs an uplink transmission beam prediction procedure based on the at least one downlink transmission; and obtain an indication that the UE supports a beam correspondence capability for the uplink transmission beam prediction procedure meeting at least one of a set of confidence levels for the beam correspondence, wherein a predicted uplink transmission beam is selected based on the set of confidence levels for the beam correspondence. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 includes means for providing at least one downlink transmission. A UE performs an uplink transmission beam prediction procedure based on the at least one downlink transmission. The network entity includes means for obtaining an indication that the UE supports a beam correspondence capability for the uplink transmission beam prediction procedure meeting at least one of a set of confidence levels for the beam correspondence. A predicted uplink transmission beam is selected based on the set of confidence levels for the beam correspondence. The network entity further includes means for obtaining a report of support for multiple capabilities associated with the set of confidence levels for the beam correspondence. The support is reported in at least one of a UE RRC capability during initial access, a MAC-CE, or UCI. The network entity further includes means for providing a beam correspondence configuration indicating at least one of a first periodicity for a measurement cycle or a second periodicity for a prediction cycle comprising resources allocated for the UE to determine whether the beam correspondence is supported. The beam correspondence configuration is provided via at least one of RRC signaling or MAC-CE. The network entity further includes means for obtaining support for at least one of a first maximum number of configured reference signal candidates that the UE supports for the uplink transmission beam prediction procedure, or a second maximum number of activated reference signal candidates that the UE supports for the uplink transmission beam prediction procedure. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE comprising performing an uplink transmission beam prediction procedure based on at least one downlink transmission, wherein a predicted uplink transmission beam is selected based on a set of confidence levels for a beam correspondence; and transmitting an indication of support for a beam correspondence capability for the uplink transmission beam prediction procedure meeting at least one of the set of confidence levels for the beam correspondence.

Aspect 2 is the method of aspect 1, further including reporting the support for multiple capabilities associated with the set of confidence levels for the beam correspondence, wherein the support is reported in at least one of a UE RRC capability during initial access, a MAC-CE, or UCI.

Aspect 3 is the method of any of aspects 1 and 2, further includes that the beam correspondence capability is based on a probability of a beam correspondence level being fulfilled for the uplink transmission beam prediction procedure based on temporal down sampled downlink beam measurements.

Aspect 4 is the method of any of aspects 1-3, further includes that the beam correspondence capability is for the uplink transmission beam prediction procedure based on a machine learning prediction for a downlink beam.

Aspect 5 is the method of any of aspects 1-4, further including identifying a receive beam that corresponds to the at least one downlink transmission; identifying an uplink transmission beam based on the receive beam that corresponds to the at least one downlink transmission; and comparing the uplink transmission beam based on the receive beam that corresponds to the at least one downlink transmission with the predicted uplink transmission beam based on the uplink transmission beam prediction procedure.

Aspect 6 is the method of any of aspects 1-5, further includes that a comparison of the uplink transmission beam and the predicted uplink transmission beam is performed to obtain a variance measurement, wherein results of the variance measurement are referenced with one or more thresholds for the beam correspondence to determine whether the beam correspondence is supported by the UE.

Aspect 7 is the method of any of aspects 1-6, further includes that the beam correspondence is supported by the UE in response to the results of the variance measurement being within the one or more thresholds for the beam correspondence.

Aspect 8 is the method of any of aspects 1-7, further including receiving a configuration of a downlink reference signal for the beam correspondence via the uplink transmission beam prediction procedure; and measuring the downlink reference signal within a measurement cycle having a first periodicity, wherein the UE performs the uplink transmission beam prediction procedure based on a prediction cycle that has a second periodicity that is less than the first periodicity of the measurement cycle for the downlink reference signal.

Aspect 9 is the method of any of aspects 1-8, further includes that the downlink reference signal has a third periodicity that is less than the first periodicity of the measurement cycle, and the downlink reference signal includes at least one of a SSB resource for the beam correspondence via the uplink transmission beam prediction procedure, a periodic NZP-CSI-RS resource for the beam correspondence via the uplink transmission beam prediction procedure, or a semi-persistent NZP-CSI-RS resource dedicated for the beam correspondence for the beam correspondence via the uplink transmission beam prediction procedure.

Aspect 10 is the method of any of aspects 1-9, further includes that a comparison of the predicted uplink transmission beam based on a receive beam that corresponds to the downlink reference signal with the predicted uplink transmission beam occurs within the measurement cycle of the downlink reference signal, wherein an uplink transmission spatial filter based on a downlink reception spatial filter is utilized to receive the at least one downlink transmission at measurement occasions, wherein the uplink transmission beam prediction procedure occurs within the prediction cycle after the measurement cycle of the downlink reference signal.

Aspect 11 is the method of any of aspects 1-10, further includes that the set of confidence levels for the beam correspondence are based on the predicted uplink transmission beam, within the prediction cycle, having a radiated power at a peak transmission power direction that meets a threshold in comparison to a reference uplink transmission beam.

Aspect 12 is the method of any of aspects 1-11, further includes that the threshold is based on at least one of a comparison to the reference uplink transmission beam, a direction of the peak transmission power direction of the predicted uplink transmission beam, or at least one of a minimum peak EIRP or a spherical coverage for the predicted uplink transmission beam.

Aspect 13 is the method of any of aspects 1-12, further includes that the UE identifies an uplink transmission spatial filter based on a downlink reception spatial filter to receive the at least one downlink transmission.

Aspect 14 is the method of any of aspects 1-13, further including determining that the beam correspondence is supported by the UE during the prediction cycle of the uplink transmission beam prediction procedure based on at least on a transmission power difference between the predicted uplink transmission beam and an uplink beam based on measurement of the at least one downlink transmission.

Aspect 15 is the method of any of aspects 1-14, further including receiving a beam correspondence configuration indicating at least one of the first periodicity for the measurement cycle or the second periodicity for the prediction cycle comprising resources allocated for the UE to determine whether the beam correspondence is supported, wherein the beam correspondence configuration is received via at least one of RRC signaling or a MAC-CE.

Aspect 16 is the method of any of aspects 1-15, further includes that the beam correspondence capability is based on at least one of a minimum L1 RSRP measured for the downlink reference signal, an association between the first periodicity of the measurement cycle and the second periodicity for the prediction cycle, or a maximum or minimum achievable confidence level of the beam correspondence based on the uplink transmission beam prediction procedure.

Aspect 17 is the method of any of aspects 1-16, further including indicating support for at least one of a first maximum number of configured reference signal candidates that the UE supports for the uplink transmission beam prediction procedure, or a second maximum number of activated reference signal candidates that the UE supports for the uplink transmission beam prediction procedure.

Aspect 18 is an apparatus for wireless communication at a UE including at least one processor coupled to a memory and at least one transceiver, the at least one processor configured to implement any of Aspects 1-17.

Aspect 19 is an apparatus for wireless communication at a UE including means for implementing any of Aspects 1-17.

Aspect 20 is a computer-readable medium storing computer executable code, where the code when executed by a processor causes the processor to implement any of Aspects 1-17.

Aspect 21 is a method of wireless communication at a network entity comprising providing at least one downlink transmission, wherein a UE performs an uplink transmission beam prediction procedure based on the at least one downlink transmission; and obtaining an indication that the UE supports a beam correspondence capability for the uplink transmission beam prediction procedure meeting at least one of a set of confidence levels for a beam correspondence, wherein a predicted uplink transmission beam is selected based on a set of confidence levels for the beam correspondence.

Aspect 22 is the method of aspect 21, further including obtaining a report of support for multiple capabilities associated with the set of confidence levels for the beam correspondence, wherein the support is reported in at least one of a UE RRC capability during initial access, a MAC-CE, or UCI.

Aspect 23 is the method of any of aspects 21 and 22, further includes that the set of confidence levels for the beam correspondence based on the predicted uplink transmission beam is based on downlink beam measurements.

Aspect 24 is the method of any of aspects 21-23, further includes that the set of confidence levels for the beam correspondence are based on the predicted uplink transmission beam, within a prediction cycle, having a radiated power at a peak transmission power direction that meets a threshold in comparison to a reference uplink transmission beam.

Aspect 25 is the method of any of aspects 21-24, further includes that the threshold is based on at least one of a comparison to the reference uplink transmission beam, a direction of the peak transmission power direction of the predicted uplink transmission beam, or at least one of a minimum peak EIRP or a spherical coverage for the predicted uplink transmission beam.

Aspect 26 is the method of any of aspects 21-25, further includes that the UE identifies an uplink transmission spatial filter based on a downlink reception spatial filter to receive the at least one downlink transmission.

Aspect 27 is the method of any of aspects 21-26, further including providing a beam correspondence configuration indicating at least one of a first periodicity for a measurement cycle or a second periodicity for a prediction cycle comprising resources allocated for the UE to determine whether the beam correspondence is supported, wherein the beam correspondence configuration is provided via at least one of RRC signaling or MAC-CE.

Aspect 28 is the method of any of aspects 21-27, further includes that the beam correspondence capability is based on at least one of a minimum L1 RSRP measured for a downlink reference signal, an association between a first periodicity of a measurement cycle and a second periodicity for a prediction cycle, or a maximum or minimum achievable confidence level of the beam correspondence based on the uplink transmission beam prediction procedure.

Aspect 29 is the method of any of aspects 21-28, further including obtaining support for at least one of a first maximum number of configured reference signal candidates that the UE supports for the uplink transmission beam prediction procedure, or a second maximum number of activated reference signal candidates that the UE supports for the uplink transmission beam prediction procedure.

Aspect 30 is an apparatus for wireless communication at a network entity including at least one processor coupled to a memory and at least one transceiver, the at least one processor configured to implement any of Aspects 21-29.

Aspect 31 is an apparatus for wireless communication at a network entity including means for implementing any of Aspects 21-29.

Aspect 32 is a computer-readable medium storing computer executable code, where the code when executed by a processor causes the processor to implement any of Aspects 21-29.

1. An apparatus for wireless communication at a user equipment (UE), comprising:
a memory; and
at least one processor coupled to the memory and, based at least in part on information stored in the memory, the at least one processor is configured to:
perform an uplink transmission beam prediction procedure based on at least one downlink transmission, wherein a predicted uplink transmission beam is selected based on a set of confidence levels for a beam correspondence; and
transmit an indication of support for a beam correspondence capability for the uplink transmission beam prediction procedure meeting at least one of the set of confidence levels for the beam correspondence.

2. The apparatus of claim 1, further comprising a transceiver coupled to the at least one processor.

3. The apparatus of claim 1, wherein the at least one processor is configured to:
report the support for multiple capabilities associated with the set of confidence levels for the beam correspondence, wherein the support is reported in at least one of a UE radio resource control (RRC) capability during initial access, a medium access control (MAC) control element (CE) (MAC-CE), or uplink control information (UCI).

4. The apparatus of claim 1, wherein the beam correspondence capability is based on a probability of a beam correspondence level being fulfilled for the uplink transmission beam prediction procedure based on temporal down sampled downlink beam measurements.

5. The apparatus of claim 4, wherein the beam correspondence capability is for the uplink transmission beam prediction procedure based on a machine learning prediction for a downlink beam.

6. The apparatus of claim 1, wherein the at least one processor is configured to:
identify a receive beam that corresponds to the at least one downlink transmission;
identify an uplink transmission beam based on the receive beam that corresponds to the at least one downlink transmission; and
compare the uplink transmission beam based on the receive beam that corresponds to the at least one downlink transmission with the predicted uplink transmission beam based on the uplink transmission beam prediction procedure.

7. The apparatus of claim 6, wherein a comparison of the uplink transmission beam and the predicted uplink transmission beam is performed to obtain a variance measurement, wherein results of the variance measurement are referenced with one or more thresholds for the beam correspondence to determine whether the beam correspondence is supported by the UE.

8. The apparatus of claim 7, wherein the beam correspondence is supported by the UE in response to the results of the variance measurement being within the one or more thresholds for the beam correspondence.

9. The apparatus of claim 1, wherein the at least one processor is configured to:
receive a configuration of a downlink reference signal for the beam correspondence via the uplink transmission beam prediction procedure; and
measure the downlink reference signal within a measurement cycle having a first periodicity, wherein the UE performs the uplink transmission beam prediction procedure based on a prediction cycle that has a second periodicity that is less than the first periodicity of the measurement cycle for the downlink reference signal.

10. The apparatus of claim 9, wherein the downlink reference signal has a third periodicity that is less than the first periodicity of the measurement cycle, and the downlink reference signal includes at least one of:
a synchronization signal block (SSB) resource for the beam correspondence via the uplink transmission beam prediction procedure,
a periodic non-zero power channel state information reference signal (NZP-CSI-RS) resource for the beam correspondence via the uplink transmission beam prediction procedure, or
a semi-persistent NZP-CSI-RS resource dedicated for the beam correspondence for the beam correspondence via the uplink transmission beam prediction procedure.

11. The apparatus of claim 9, wherein a comparison of the predicted uplink transmission beam based on a receive beam that corresponds to the downlink reference signal with the predicted uplink transmission beam occurs within the measurement cycle of the downlink reference signal, wherein an uplink transmission spatial filter based on a downlink reception spatial filter is utilized to receive the at least one downlink transmission at measurement occasions, wherein the uplink transmission beam prediction procedure occurs within the prediction cycle after the measurement cycle of the downlink reference signal.

12. The apparatus of claim 9, wherein the set of confidence levels for the beam correspondence are based on the predicted uplink transmission beam, within the prediction cycle, having a radiated power at a peak transmission power direction that meets a threshold in comparison to a reference uplink transmission beam.

13-17. (canceled)

18. The apparatus of claim 1, wherein the at least one processor is configured to:
indicate support for at least one of:
a first maximum number of configured reference signal candidates that the UE supports for the uplink transmission beam prediction procedure, or
a second maximum number of activated reference signal candidates that the UE supports for the uplink transmission beam prediction procedure.

19. A method of wireless communication at a user equipment (UE), comprising:
performing an uplink transmission beam prediction procedure based on at least one downlink transmission, wherein a predicted uplink transmission beam is selected based on a set of confidence levels for a beam correspondence; and
transmitting an indication of support for a beam correspondence capability for the uplink transmission beam prediction procedure meeting at least one of the set of confidence levels for the beam correspondence.

20. An apparatus for wireless communication at a network entity, comprising:
a memory; and
at least one processor coupled to the memory and, based at least in part on information stored in the memory, the at least one processor is configured to:
provide at least one downlink transmission, wherein a user equipment (UE) performs an uplink transmission beam prediction procedure based on the at least one downlink transmission; and
obtain an indication that the UE supports a beam correspondence capability for the uplink transmission beam prediction procedure meeting at least one of a set of confidence levels for a beam correspondence, wherein a predicted uplink transmission beam is selected based on a set of confidence levels for the beam correspondence.

21-23. (canceled)

24. The apparatus of claim 20, wherein the set of confidence levels for the beam correspondence are based on the predicted uplink transmission beam, within a prediction cycle, having a radiated power at a peak transmission power direction that meets a threshold in comparison to a reference uplink transmission beam.

25. The apparatus of claim 24, wherein the threshold is based on at least one of:
a comparison to the reference uplink transmission beam,
a direction of the peak transmission power direction of the predicted uplink transmission beam, or
at least one of a minimum peak equivalent isotropic radiated power (EIRP) or a spherical coverage for the predicted uplink transmission beam.

26. The apparatus of claim 24, wherein the UE identifies an uplink transmission spatial filter based on a downlink reception spatial filter to receive the at least one downlink transmission.

27. The apparatus of claim 20, wherein the at least one processor is configured to:
provide a beam correspondence configuration indicating at least one of a first periodicity for a measurement cycle or a second periodicity for a prediction cycle comprising resources allocated for the UE to determine whether the beam correspondence is supported, wherein the beam correspondence configuration is provided via at least one of radio resource control (RRC) signaling or medium access control (MAC) control element (CE) (MAC-CE).

28. The apparatus of claim 20, wherein the beam correspondence capability is based on at least one of:
a minimum layer 1 (L1) reference signal received power (RSRP) measured for a downlink reference signal,
an association between a first periodicity of a measurement cycle and a second periodicity for a prediction cycle, or
a maximum or minimum achievable confidence level of the beam correspondence based on the uplink transmission beam prediction procedure.

29-30. (canceled)
